(19) United States
(12) Patent Application Publication
(10) Pub. No.: US 2007/0137772 A1
(43) Pub. Date: Jun. 21, 2007

(54) Adhesive tape applicator for tire pressure sensors

(75) Inventor: Suavi Seckin Sekeroglu, Rochester, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation

(21) Appl. No.: 11/489,652

(22) Filed: Jul. 19, 2006

Related U.S. Application Data
(60) Provisional application No. 60/750,895, filed on Dec. 16, 2005.

(51) Int. Cl. B32B 37/12

(52) U.S. Cl. 156/212; 156/60; 156/349

(57) ABSTRACT

An adhesive applicator system includes an adhesive tape adapted to be secured to a structure such as a bracket for a tire pressure sensor. The bracket includes a concave, curved surface for receiving the adhesive tape and includes a first radius between upper and lower design tolerances. An applicator head carries the adhesive tape and includes a second radius that is less than a mid-point between the upper and lower design tolerances. In one example, the second radius is approximately equal to or less than the lower design tolerance. The adhesive tape is applied to the curved surface by initially engaging the curved surface with the adhesive tape in a single contact area. In one example, the single contact area is located at an intermediate portion of the bracket. Subsequent to engaging the single contact area, the curved surface is fully engaged with the adhesive tape moving outward from the single contact area in opposite directions toward opposing end portions of the bracket. The bracket, with its adhesive tape, is secured onto a circumference of a wheel for carrying a tire pressure sensor.

The application claims priority to U.S. Provisional Application No. 60/750,895 which was filed on Dec. 15, 2005.

### BACKGROUND OF THE INVENTION

This invention relates to an adhesive applicator system and method for applying an adhesive tape to a tire pressure sensor bracket used on vehicle wheels.

Tire pressure monitoring systems are becoming more prevalent in vehicles. One type of tire pressure monitoring system includes a bracket that carries a tire pressure sensor. The bracket is secured to a circumference of the wheel interiorly of the tire by a double-sided adhesive tape and a steel band.

It is desirable that the adhesive tape entirely engage the adjoining surface of the bracket. Since the bracket engages the circumference of the wheel, the bracket surface is curved. One typical bracket material is stainless steel, which does not retain its radius over a tight tolerance once the concave, curved surface has been formed during manufacturing of the bracket.

A tape applicator is used to apply the adhesive tape to the curved surface. Previously, the radius of the surface of an applicator head has been selected so that the radius is equal to the mid-point of the tolerance range for the curved surface of the bracket. As a result, for small radius curved surfaces at the low end of the range, the applicator surface will engage opposing end portions of the curved surface simultaneously so that the applicator head must stretch the adhesive tape to engage an intermediate portion of the curved surface. This results in wrinkles and trapped air bubbles under the tape, which provides less than desired engagement between the bracket and circumference of the wheel.

What is needed is an adhesive tape applicator system and method in which the adhesive tape fully engages the curved surface of the bracket across the entire design tolerance range for the curved surface.

### SUMMARY OF THE INVENTION

An adhesive applicator system includes an adhesive tape adapted to be secured to a structure such as a bracket for a tire pressure sensor. The bracket includes a concave, curved surface for receiving the adhesive tape and includes a first radius between upper and lower design tolerances. An applicator head carries the adhesive tape and includes a second radius that is less than a mid-point of the design tolerance range. In one example, the second radius is approximately equal to or less than the lower design tolerance.

The adhesive tape is applied to the curved surface by initially engaging the curved surface with the adhesive tape in a single contact area. In one example, the single contact area is located at an intermediate portion of the bracket. Subsequent to engaging the single contact area, the curved surface is fully engaged with the adhesive tape moving outward from the single contact area in opposite directions toward opposing end portions of the bracket. The bracket, with its adhesive tape, is secured onto a circumference of a wheel for carrying a tire pressure sensor.

Accordingly, the applicator head will ensure that the adhesive tape fully engages the curved surface across its entire design tolerance range.

These and other features of the present invention can be best understood from the following specification and drawings, the following of which is a brief description.

### BRIEF DESCRIPTION OF THE DRAWINGS

FIG. 1 is a perspective view of an example tire pressure sensor bracket secured to a circumference of a wheel.

FIG. 2 is a perspective view of an example adhesive tape applicator system for the tire pressure sensor bracket shown in FIG. 1.

FIG. 3 is a side perspective view of an applicator head and the bracket.

FIG. 4 is a perspective view of the bracket illustrating the engagement of the adhesive tape with the curved surface.

### DETAILED DESCRIPTION OF THE PREFERRED EMBODIMENT

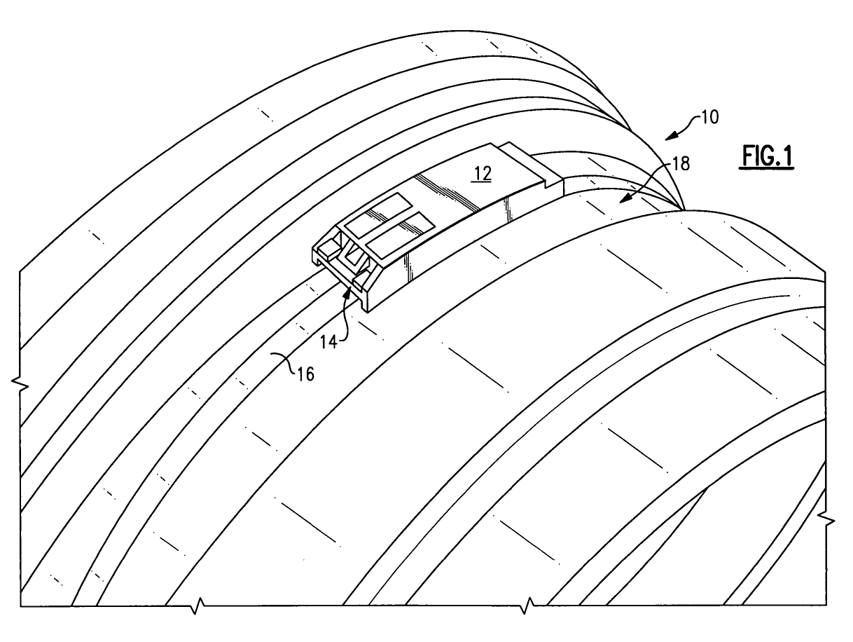

A wheel 10 is shown in FIG. 1. A tire pressure sensor 12 is mounted on a bracket 14 that is secured to a circumference 18 of the wheel 10 by a band 16. Additionally, an adhesive tape is used to secure a concave, curved surface of the bracket 14 (not shown in FIG. 1).

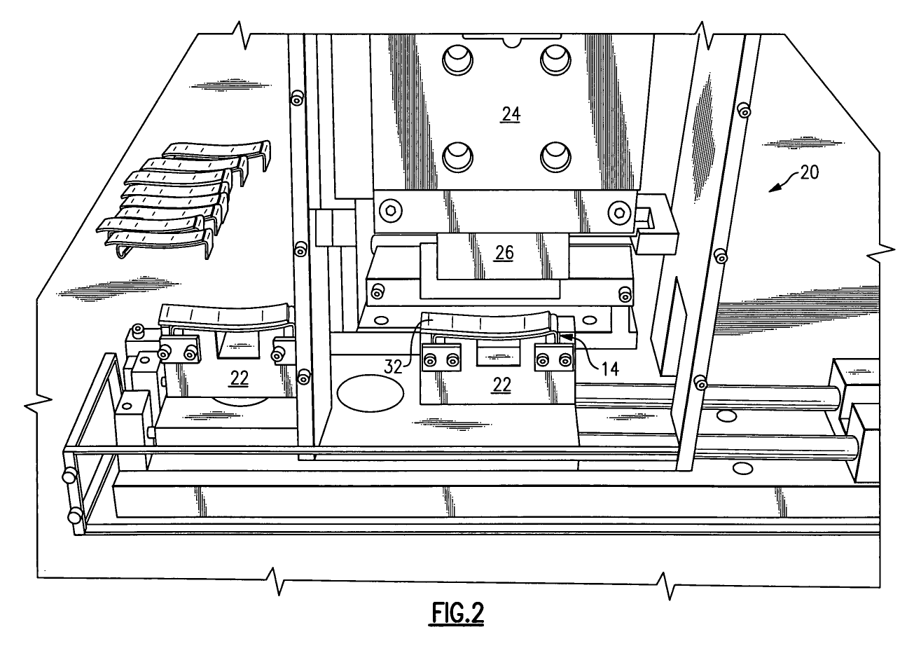

Referring to FIG. 2, a tape applicator 20 applies the adhesive tape 32 to the bracket 14. In one example, fixtures 22 position the brackets 14 beneath a tape dispenser 24 having an applicator head 26. The applicator head 26 applies the adhesive tape 32 to the bracket 14.

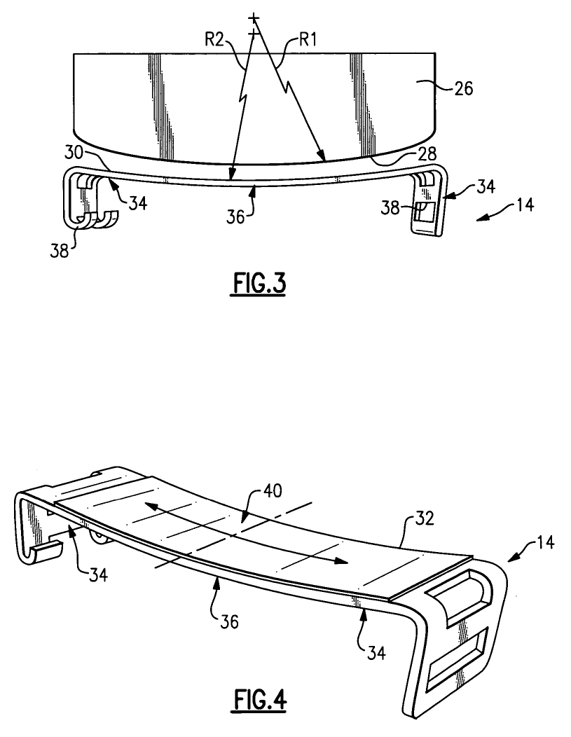

Referring to FIG. 3, the bracket 14 includes a curved surface 30 to which the adhesive tape 32 is applied. The curved surface is concave so that it is generally complimentary to the curvature of the circumference 18 of the wheel. In the example shown, the bracket 14 includes opposing end portions 34 and an intermediate portion 36. Attachment features extend transversely from the curved surface and are used for securing the tire pressure sensor 12 to the bracket 14.

The curved surface 30 includes a radius R2 that lies within a design tolerance range. In one example, the upper tolerance is 223 mm and the lower tolerance is 201 mm. The applicator head 26 includes an applicator surface 28 that applies the adhesive tape 32 to the curved surface 30. Prior art applicator heads use an applicator surface 28 having a radius of 212 mm for the example range, which is the mid-point of the design tolerance range. The example applicator surface 28 utilizes a radius R1 that is less than the mid-point of the design tolerance range. In one example, the radius R1 is approximately equal to or less than the lower design tolerance. For the example given, a suitable radius R1 may be 201.5 mm, 201.5 mm or 200.5 mm.

Referring to FIG. 4, the adhesive tape 32 carried by the applicator head 26 (not shown) will engage the intermediate portion 36 at a single contact area 40. The adhesive tape 32 generally make line contact with the center of the curved surface 30, in the example shown. As the applicator head 26 continues to move downward, the adhesive tape 32 will engage the rest of the curved surface 30 moving away from the contact area 40 in both directions toward the opposing end portions 34. In this manner, the adhesive tape 32 will fully engage the curved surface 30 across the entire design tolerance of the curved surface.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An adhesive applicator system comprising:
an adhesive tape;
a structure including a curved surface for receiving the adhesive tape, the curved surface having a first radius between an upper and lower design tolerance; and
an applicator head carrying the adhesive tape and including a second radius less than a midpoint between the upper and lower design tolerance.

2. The system according to claim 1, wherein the second radius is approximately equal to the lower design tolerance.

3. The system according to claim 2, wherein the second radius is equal to or less than the lower design tolerance.

4. The system according to claim 1, wherein the curved surface is concave, the structure including opposing end portions and an intermediate portion, the applicator head adapted to initially engage the intermediate portion at a single contact area.

5. The system according to claim 4, wherein the structure is a tire pressure sensor bracket, and the end portions include attachment features adapted to secure a tire pressure sensor to the bracket.

6. A method of applying adhesive tape comprising the steps of:
a) providing a structure having a curved surface with a radius in a lower half of a design tolerance range for the curved surface;
b) initially engaging the curved surface with an adhesive tape in a single contact area; and
c) fully engaging the curved surface with the adhesive tape subsequent to performing step b).

7. The method according to claim 6, wherein the curved surface is concave.

8. The method according to claim 7, wherein the structure includes opposing end portions and an intermediate portion, the single contact area located on the intermediate portion.

9. The method according to claim 8, wherein step (c) includes engaging the curved surface with the adhesive tape moving in opposite directions away from the single contact area toward the opposing end portions.

10. The method according to claim 6, wherein the structure is a tire pressure sensor bracket, and the end portions include attachment features.

11. The method according to claim 10, comprising step (d) applying the adhesive to a circumference of a wheel.

12. The method according to claim 11, comprising step (e) securing a tire pressure sensor to the attachment features.

13. A method of manufacturing an adhesive tape applicator comprising the steps of:
a) determining the upper and lower design tolerances for a first radius of a curved surface that is adapted to receive adhesive tape; and
b) producing an applicator head adapted apply the tape to the curved surface, the applicator head have a second radius that is less than a midpoint between the upper and lower design tolerances.

14. The method according to claim 13, wherein the curved surface is concave and the applicator head includes an applicator surface that is convex, the applicator surface defined by the second radius.

15. The method according to claim 13, wherein the second radius is approximately equal to the lower design tolerance.

16. The method according to claim 15, wherein the second radius is equal to or less than the lower design tolerance.
